(19) United States
(12) Patent Application Publication
(10) Pub. No.: US 2009/0026861 A1
(43) Pub. Date: Jan. 29, 2009

(54) GENERATOR FOR EXERCISE EQUIPMENT

(76) Inventors: Ching-Biau Tzeng, Tainan Hsien (TW); Chun-Hao Lu, Tainan Hsien (TW); Cheng-Chi Tai, Tainan City (TW)

Correspondence Address: WPAT, PC;INTELLECTUAL PROPERTY ATTORNEYS, 2030 MAIN STREET, SUITE 1300, IRVINE, CA, 92614, US

(21) Appl. No.: 11/782,153

(22) Filed: Jul. 24, 2007

(51) Int. Cl. H02K 5/00; H02K 1/26

(52) U.S. Cl. 310/89; 310/268

(57) ABSTRACT

A generator for exercise equipment includes a disc and a case. The case has a surface. A number of first locating holes are disposed on the surface to accommodate coils therein. The case is pivotally connected to the disc. The case has an inner wall. A number of second locating holes are disposed on the inner wall of the case to accommodate magnets therein. By spinning, the disc is spinning with respect to the case so that the electricity is generated thereafter.

### BACKGROUND OF THE INVENTION

1. Field of the invention

The present invention relates to a generator for exercise equipment, and more particularly to one having a disc and a case to produce a relative motion to generate electricity, which has a small size and is easy to manufacture.

2. Description of the Prior Art

There are a few exercise apparatuses using a generator to operate the apparatuses, such as exercise treadmills, jogging machines, exercise bicycles and so on. A conventional generator, as shown in FIG. 4, comprises a stator device A and a rotor device B. The stator device A has a number of stators A1 arranged in radiated status. Each stator A1 is winding with coils A2. The rotor device B comprises a number of magnets B2 secured to an inner wall B1 of the rotor device B. When the rotor device B rotates, the relative motion between the coils A2 and the magnets B2 will produce electromagnetic induction. The faster the magnets B2 move, the more induced current will be generated by the coils A2. However, the coils A2 require a lot of manpower in manufacture and in installation. Because all the magnets B2 are disposed on the inner wall B1 of the rotor device B, the diameter of the rotor device B is relatively large.

### SUMMARY OF THE INVENTION

According to the present invention, there is provided a generator for exercise equipment comprising a disc having a surface, a number of first locating holes being disposed on said surface to accommodate coils therein; and a case pivotally connected to said disc, said case having an inner wall, a number of second locating holes being disposed on said inner wall to accommodate magnets therein.

Preferably, said case is provided with an axle to connect with said disc.

It is the primary object of the present invention to provide a generator for exercise equipment, which increases the efficiency of generating electric power.

It is another object of the present invention to provide a generator for exercise equipment, which has a compact size compared with the prior art and is easy to install so as to save manpower.

### BRIEF DESCRIPTION OF THE DRAWINGS

FIG. 1 is an exploded view of the present invention;

FIG. 2 is a side cross-sectional view of the present invention;

FIG. 3 is a side view of the present invention mounted to an exercise apparatus; and

FIG. 4 is a side cross-sectional view of the prior art.

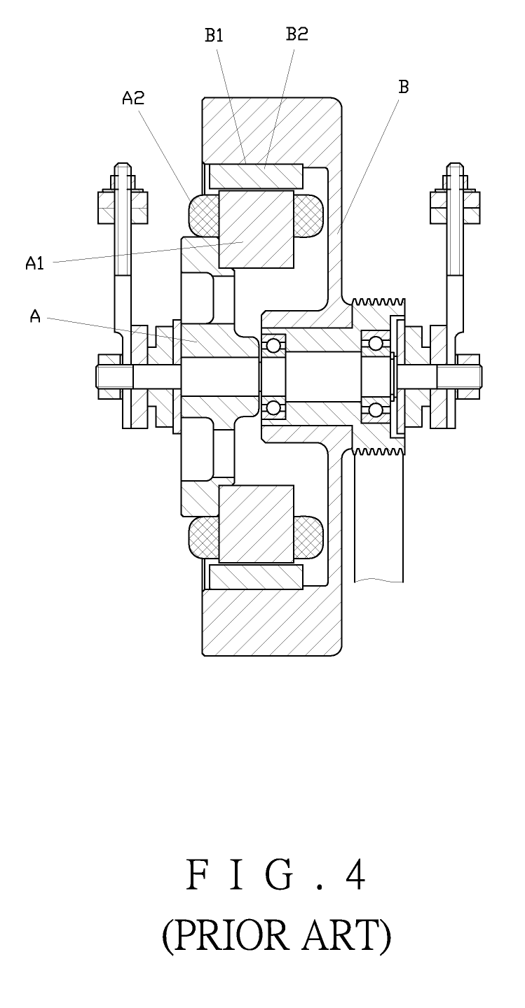

### DETAILED DESCRIPTION OF THE PREFERRED EMBODIMENT

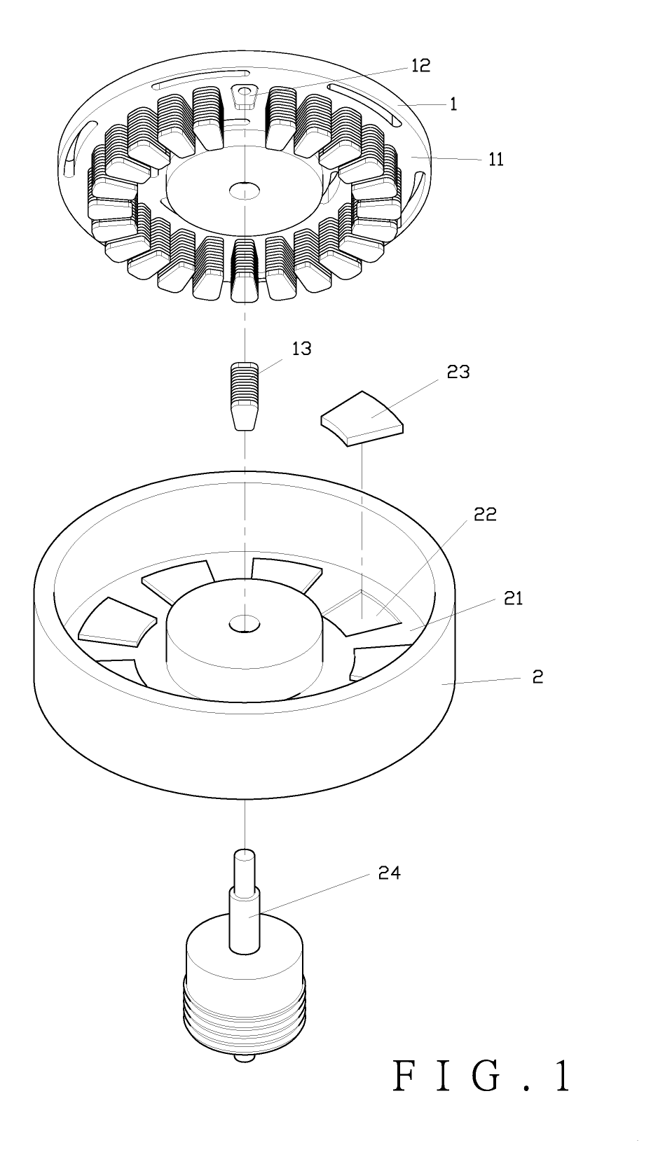

As shown in FIG. 1, a preferred embodiment of the present invention comprises a disc 1 and a case 2.

The disc 1 has a surface 11. A number of first locating holes 12 equally spaced each other are disposed on the surface 11 to accommodate coils 13 therein.

The case 2 is pivotally connected to the disc 1. The case 2 has an inner wall 21. A number of second locating holes 22 equally spaced each other are disposed on the inner wall 21 to accommodate magnets 23 therein. An axle 24 is inserted through the center of the case 2 and connected to the disc 1. When the axle 24 spins, the case 2 and the disc 1 will produce a relative motion.

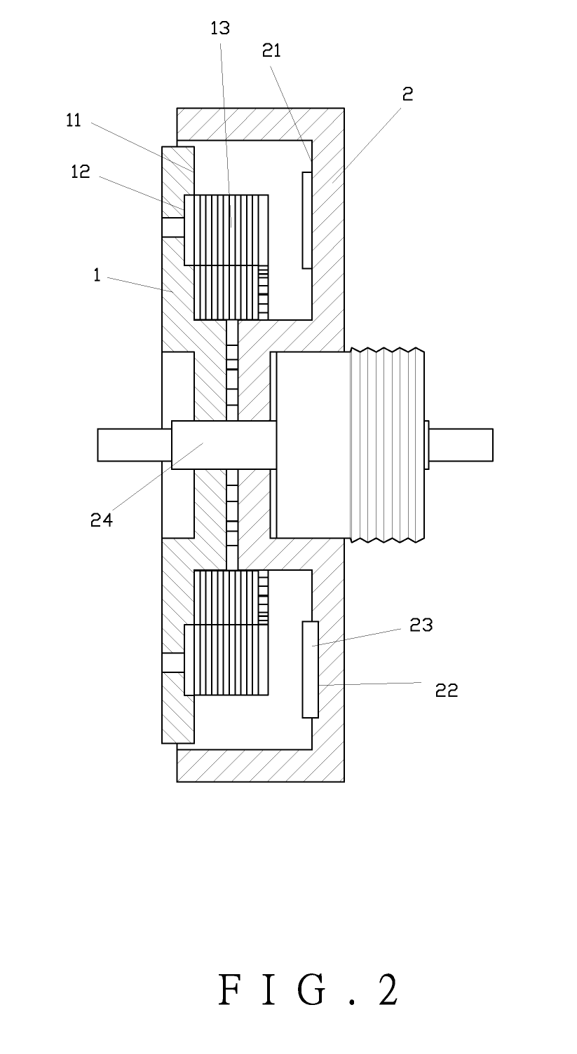

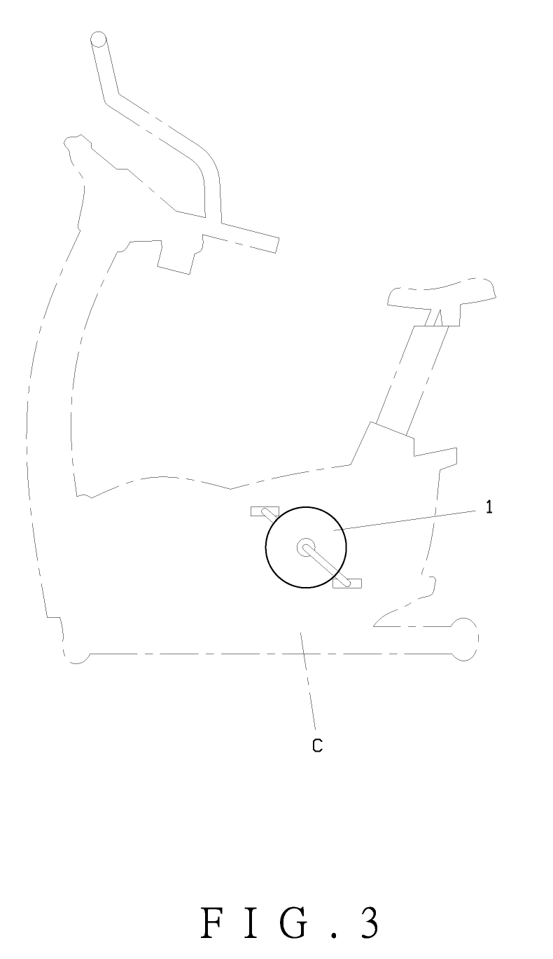

To operate the present invention, as shown in FIGS. 2 and 3, the disc 1 and the case 2 are connected by the axle 24 and then secured to an exercise apparatus C. When the user steps the pedals of the exercise apparatus C, the axle 24 is linked to spin. The axle 24 may be linked to spin by means of other transmission elements. When the axle 24 spins, the relative motion of the disc 1 and the case 2 will produce electromagnetic induction between the magnets 23 and the coils 13 to generate electricity.

What is claimed is:

1. A generator for exercise equipment comprising:
a disc having a surface, a number of first locating holes being disposed on said surface to accommodate coils therein; and
a case pivotally connected to said disc, said case having an inner wall, a number of second locating holes being disposed on said inner wall to accommodate magnets therein.

2. The generator for exercise equipment, as recited in claim 1, wherein said case is provided with an axle to connect with said disc.
